(19) United States
(12) Patent Application Publication
(10) Pub. No.: US 2005/0080517 A1
(43) Pub. Date: Apr. 14, 2005

(54) Vehicle data bus system comprising a sensor module

(76) Inventors: Peter Hiemer, Aichtal (DE); Martin Keppler, Horb (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/496,583

(22) PCT Filed: Nov. 12, 2002
(86) PCT No.: PCT/EP02/12605

(30) Foreign Application Priority Data
Nov. 22, 2001 (DE) 101 57 377.4

(51) Int. Cl. G06F 7/00

(52) U.S. Cl. 701/1; 701/91

(57) ABSTRACT

A vehicle data bus system having one or more data buses, via which a plurality of connected bus users are connected for data transmission, having a sensor module which is embodied as a bus user and has a rotational speed sensor, the sensor module being configured to output rotational speed data onto the data bus, and having a vehicle movement dynamics/wheel slip control system which is embodied as a bus user and which is designed to receive at least the rotational speed data via the data bus. At least one further bus user is designed to receive the rotational speed data via the data bus, the sensor module is configured to preprocess the rotational speed data and to output the preprocessed rotational speed data onto the data bus, and the vehicle movement dynamics/wheel slip control system and/or the further bus user are configured to perform an offset correction of the received preprocessed rotational speed data.

The application claims the priority of German Patent Document No. 101 57 377.4, filed 22 Nov. 2001 and PCT/EP02/12605, filed 12 Nov. 2002 the disclosure of which is expressly incorporated by reference herein, respectively.

### BACKGROUND AND SUMMARY OF THE INVENTION

The invention relates to a vehicle data bus system having a sensor module.

International Application Document WO 99/47889 discloses a sensor module with data bus connection. In the sensor module, at least two sensors for sensing vehicle movements of the vehicle and an evaluation unit for carrying out preprocessing and offset correction of the sensor data signals are spatially combined in one sensor module. The, sensors are longitudinal acceleration sensors, transverse acceleration sensors and/or rotational speed sensors. The sensor data is made available by the sensor module to the vehicle movement dynamics/wheel slip control systems, brake control systems, steering control systems, ride level control systems and engine management control systems. The sensor module outputs rotational speed sensor data in the form of angle of rotation data, angle of rotation speed data, angle of rotation acceleration data, onto a CAN data bus (CAN: Controller Area Network). The preprocessing of the sensor data signals which includes oversampling, integration and filtering is carried out in the evaluation unit of the sensor module. In addition, effects which are due to temperature influences are compensated in the evaluation unit of the sensor module.

German Patent Document DE 199 44 177 A1 discloses a vehicle data bus system having a locating module as a bus user. The locating module includes at least one GPS receiver and evaluation means. The locating module is configured to receive rotational speed data from a vehicle movement dynamics/wheel slip control system via the data bus, and to acquire locating data. The locating module is also capable of outputting acquired locating data onto the data bus.

The object of the invention is to provide a vehicle data bus system of the above-discussed type which makes available rotational speed data which can be used in comparatively varied and flexible ways.

The vehicle data bus system of the present invention has, as bus users which are connected to one another for data transmission, at least a vehicle movement dynamics/wheel slip control system, a sensor module and a further bus user. The sensor module includes at least one rotational speed sensor and a unit for preprocessing the rotational speed sensor signals. The preprocessing of the rotational speed sensor signals includes, for example, sampling of the signals, averaging and/or integration, and low-pass filtering. The sampling is advantageously carried out as oversampling in proportion to the transmission rate of the data bus. The data bus may be, for example, a CAN bus which connects the navigation system, vehicle movement dynamics/wheel slip control systems, brake control systems, steering control systems, ride level control systems and/or engine management control systems and further bus users to one another.

According to the invention, the preprocessed rotational speed data from the sensor module is output onto the data bus. The vehicle movement dynamics/wheel slip control system receives the preprocessed rotational speed data via the data bus and carries out an offset correction of the zero displacement of the sensor data which is due, for example, to temperature. For this purpose, the vehicle movement dynamics/wheel slip control system estimates the offset in the short-term range using further data, for example wheel speed data with forward/reverse direction of travel data and/or transverse acceleration data. At least one further bus user receives the preprocessed rotational speed data via the data bus and carries out an offset correction. Depending on the type of the further bus user, the further bus user is provided, under certain circumstances, with information which permits it also to carry out an offset correction. An example of this is a navigation means which can carry out a high-quality offset correction in the long term range using a digital map and/or the part of the route just traveled and/or GPS. This permits navigation systems to be used with proven algorithms which are capable of carrying out an offset correction themselves. These navigation systems can also be used with their proven algorithms in conjunction with the vehicle data bus system according to the invention.

The vehicle movement dynamics/wheel slip control system is advantageously capable of calculating wheel travel information by using wheel speed and forward/reverse direction of travel data which is received from the wheel sensors via the data bus, and outputting the wheel travel information in the form of wheel-specific wheel pulse counters, onto the data bus. Wheel pulses will represent a specific distance traveled. For the individual wheels, the number of the wheel pulses is added in the vehicle movement dynamics/wheel slip control system and the addition sum is transmitted in a data bus message, a cyclic overflow of the value being performed when a maximum value is reached. This method of transmitting wheel travel information provides particular advantages since, when a message is lost on the data bus, the wheel travel information is nevertheless present when the next message is received.

If the offset correction has already been carried out in the sensor module, the vehicle movement dynamics/wheel slip control system and/or the further bus user can access rotational speed which has already had offset correction carried out on it. In this case, the computational work has to be performed only once in the sensor module and the further bus users can access rotational speed data which has already had offset correction performed on it. One advantageous way of implementing the offset correction in the sensor module provides for the offset to be calculated by means of the wheel speed data received via the data bus and/or forward/reverse direction of travel data and/or transverse acceleration data in the vehicle movement dynamics/wheel slip control system, and transmitted to the data bus. The sensor module receives the offset data via the data bus. In the sensor module, the offset correction is carried out and offset-corrected rotational speed data is output onto the data bus.

The vehicle data bus system includes the sensor module, the vehicle movement dynamics/wheel slip control system and/or the further bus user to alternatively and/or additionally carry out the offset correction. In this way, the greatest possible degree of flexibility is achieved in the execution of the system and it is possible to react flexibly, in terms of the configuration of the system, to particular requirements of the bus users with respect to precision, timing, etc. of the rotational speed data.

In one advantageous configuration of the invention, the vehicle movement dynamics/wheel slip control system is connected via a first data bus to the at least one further bus user. This first data bus is, for example, a CAN data bus which has a high transmission rate and via which the vehicle movement dynamics/wheel slip control systems, brake control systems, steering control systems, ride level control systems and/or engine management control systems in the vehicle are interconnected. The connection to the sensor module is made via a second data bus which may be provided, for example, exclusively for the connection between the sensor module and vehicle movement dynamics/wheel slip control system.

The vehicle movement dynamics/wheel slip control system is advantageously designed to receive rotational speed data which has been preprocessed and/or on which offset correction has been performed, from the sensor module via the second data bus. It is also designed to output onto the first data bus the rotational speed data which has been preprocessed and/or on which offset correction has been performed. The further bus users can then receive the rotational speed data which has been preprocessed and/or on which offset correction has been performed, via the first data bus.

The vehicle movement dynamics/wheel slip control system is advantageously capable of calculating offset data by using the wheel speed and forward/reverse direction of travel data received via the first data bus and obtaining the merely preprocessed rotational speed data and outputting it onto the data bus when rotational speed data on which offset correction has been performed is received via the second data bus.

The rotational speed data includes various data items which can be acquired from the rotational speed data by simple or multiple integration or differentiation. These data items include angle of rotation data, angle of rotation speeds and/or angle of rotation acceleration data. The transmission of the angle of rotation as the already integrated rotational speed via the data bus or the data buses provides particular advantages since, when a message is lost on the data bus, the angle of rotation of the vehicle is nevertheless present when the next message is received. When the rotational speed is merely transmitted, an error would occur since the change which was contained in the last message is not taken into account. The rotational speed is advantageously integrated to form the angle of rotation and transmitted in a data bus message, in which case a cyclic overflow of the integrator from 359.99° to 0°, or vice versa, is performed depending on the direction of rotation.

In one advantageous embodiment of the invention, the sensor module includes not only the rotational speed sensor but also a longitudinal acceleration sensor and/or a transverse acceleration sensor. The sensor data of these sensors is preprocessed in the sensor module, in a way analogous to the sensor data of the rotational speed sensor, and output onto the data bus.

In one advantageous embodiment of the invention, the at least one further bus user is a navigation system with an integrated locating function, or a separate locating module. It is of course, also possible to implement the navigation system and the locating module as separate bus users. The navigation system and/or the locating module can advantageously carry out an offset correction in the long-term range using the digital map and/or the route last traveled along and/or GPS. In this context, the navigation system can reconcile the direction of travel of the vehicle acquired from the rotational speed data of the sensor module with that acquired from the digital map. The navigation system and/or the locating module can perform an offset correction in the long-term range by reconciling the direction of travel of the vehicle acquired from the rotational speed data of the sensor module with the distance last traveled. One advantageous application of the rotational speed data is its use for compound navigation for navigation purposes.

Preferred exemplary embodiments of the invention are described below with reference to the associated drawings, in which, in each case in a schematic view,

### BRIEF DESCRIPTION OF THE DRAWINGS

FIG. 1 shows a vehicle data bus system with a sensor module, and

FIG. 2 shows a vehicle data bus system with a sensor module and two data buses.

### DETAILED DESCRIPTION OF THE PREFERRED EMBODIMENTS

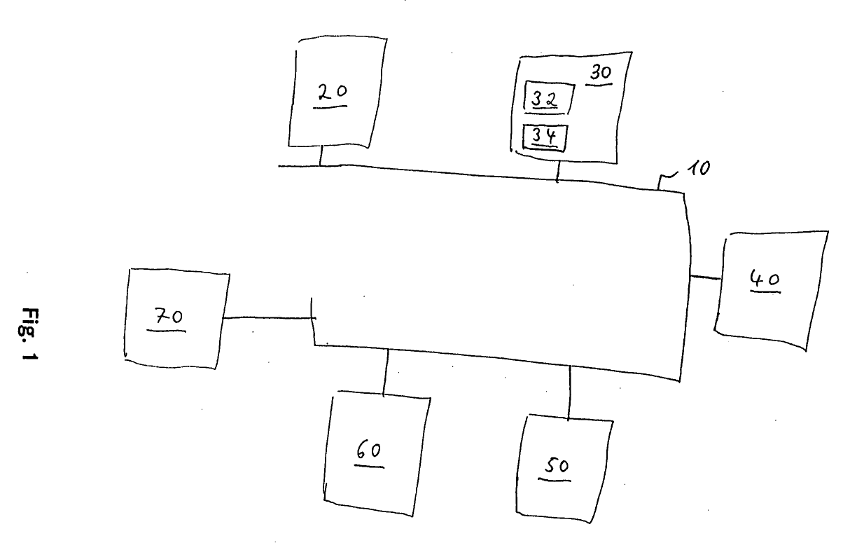

In FIG. 1, the vehicle data bus system is illustrated schematically with the data bus 10, the vehicle movement dynamics/wheel slip control system 20, the sensor module 30 with rotational speed sensor 32 and transverse acceleration sensor 34, the locating module 40, the navigation module 50, the wheel sensors 60 and the steering angle sensor 70. Oversampling of the rotational speed sensor 32 is carried out in the sensor module 30. The sampling is to be understood as oversampling in proportion to the transmission rate of the data bus 10. Then, in the sensor module 30, the averaging and low-pass filtering of the signal of the rotational speed sensor 32 are carried out. As a result, the resolution is increased and the mean-value-free noise is reduced. The preprocessed rotational speed signal is output onto the data bus 10. The compensation of the zero displacement of the rotational speed sensor which is due to the temperature point then takes place in the vehicle movement dynamics/wheel slip control system 20, in the locating module 40 and/or in the navigation module 50, i.e. the offset correction is carried out. One or more of the bus users including the vehicle movement dynamics/wheel slip control system 20, locating module 40 and/or navigation module 50 which carry out the offset correction are optionally configured to provide an output onto the data bus 10 the rotational speed data on which offset correction has been performed.

As an alternative to, or in addition to, the preprocessed data, the sensor module 30 is capable of carrying out an offset correction. For this purpose, the zero displacement, i.e. the offset, is calculated in the vehicle movement dynamics/wheel slip control system 20 from the wheel speed data received via the data bus 10 and the forward/reverse direction of travel data of the wheel sensors 60 and/or the steering angle data—received via the data bus 10—of the steering angle sensor 70, and transmitted to the sensor module 30 via the data bus 10. In the sensor module 30, the offset correction 30 is then carried out and the rotational speed data on which offset correction has been performed is output onto the data bus 10 by the sensor module 30.

As an alternative to, or in addition to, the outputting of the rotational speed data on which offset correction has been performed, the vehicle movement dynamics/wheel slip control system 20 and/or the sensor module 30 can also output onto the data bus 10 rotational speeds which have been integrated with respect to the angle of rotation. For this purpose, the preprocessed rotational speed, on which offset correction has been performed, is integrated and output onto the data bus 10 with, the integration value overflowing from 359.99° to 0°, or vice versa, depending on the direction of rotation of the vehicle. The angle of rotation corresponds to the relative direction of travel, as is used for example for compound navigation for navigation purposes. The relative direction of travel is advantageously transmitted in a message together with the wheel speed data which includes the direction of travel, and/or the wheel travel information and/or the steering angle.

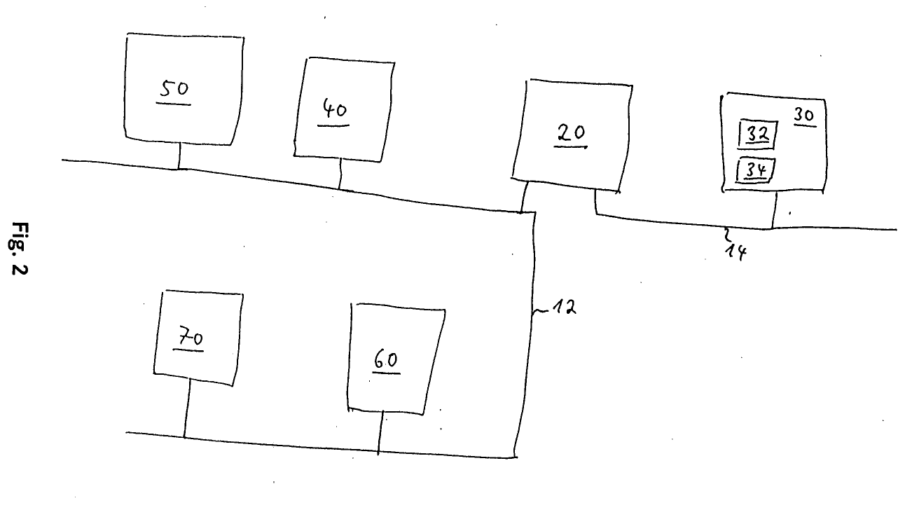

A further example of the vehicle data bus system with the first data bus 12 and the second data bus 14 is illustrated diagrammatically in FIG. 2. The vehicle movement dynamics/wheel slip control system 20 is connected via the first bus 12 to the locating module 40, the navigation module 50, the wheel sensors 60 and the steering angle sensor 70, in order to transmit data. The vehicle movement dynamics/wheel slip control system 20 is connected, for the transmission of data, to the sensor module 30 with rotational speed sensor 32 and transverse acceleration sensor 34 via the second data bus 12.

In the bus architecture in FIG. 2, the rotational speed sensor 32 is sampled in the sensor module 30. The sampling takes place as oversampling in proportion to the transmission rate of the data bus 14. Then, the averaging and low-pass filtering of the signal of the rotational speed sensor 32 takes place in the sensor module 30. As a result, the resolution is increased and the mean-value-free noise is reduced. The rotational speed signal, which is preprocessed in this way, is output onto the data bus 14. The vehicle movement dynamics/wheel slip control system 20 receives the preprocessed rotational speed data via the data bus 14 and corrects the zero displacement of the rotational speed sensor which is due to the temperature point, i.e. it carries out the offset correction. The vehicle movement dynamics/wheel slip control system 20 is optionally configured to output the rotational speed data on which offset correction has been performed, onto the data bus 12 or the data bus 14. The vehicle movement dynamics/wheel slip control system 20 can alternatively or additionally also output onto the first data bus 12 the preprocessed rotational speed data which has been received via the second data bus 14, with the result that the compensation of the zero displacement of the rotational speed sensor, which is due to the temperature point, i.e. the offset correction, can then take place in the locating module 40 and/or in the navigation module 50. The locating module 40 and/or the navigation module 50 are then optionally configured to output the rotational speed data on which offset correction has been performed, onto the data bus 12.

As an alternative or in addition to the preprocessed data, the sensor module 30 is capable of carrying out an offset correction itself. For this purpose, the zero displacement, i.e. the offset, is calculated in the vehicle movement dynamics/wheel slip control system 20 from the wheel speed data received via the data bus 12 and forward/reverse direction of travel data of the wheel sensors 60 and/or of the steering angle data—received via the data bus 12—of the steering angle sensor 70, and transmitted to the sensor module 30 via the data bus 14. In the sensor module 30, the offset correction is then carried out and the rotational speed data on which offset correction has been performed is output onto the data bus 14 by the sensor module 30. In this embodiment of the invention, the vehicle movement dynamics/wheel slip control system 20 can output, onto the data bus 12, the rotational speed data which is received via the data bus 14 and on which offset correction has been performed, and/or reconstruct the preprocessed rotational speed data using the offset and output the data onto the data bus 12.

As an alternative or in addition to outputting the rotational speed data on which offset correction has been performed, the vehicle movement dynamics/wheel slip control system 20 can also output onto the data bus 12 rotational speeds which have been integrated with respect to the angle of rotation. For this purpose, the preprocessed rotational speed on which offset correction has been performed is integrated and output onto the data bus 12, the integration value overflowing from 359.99° to 0°, and vice versa, depending on the direction of rotation of the vehicle. The angle of rotation corresponds to the relative direction of travel such as is applied, for example, for compound navigation purposes. The relative direction of travel is advantageously transmitted in a message together with the wheel speed data which includes the direction of travel and/or the wheel travel information and/or the steering angle.

Rotational speeds which have been integrated with respect to the angle of rotation can also be output onto the data bus 14 by the sensor module 30. The overflow is carried out in a way analogous to the calculation in the vehicle movement dynamics/wheel slip control system 20. The relative direction of travel is advantageously transmitted via the data bus 14 to the vehicle movement dynamics/wheel slip control system 20 and output onto the data bus 12. The data includes wheel speed data which includes the direction of travel and/or the wheel travel information and/or the steering angle.

The bus architectures which are illustrated in FIG. 1 and FIG. 2 are to be understood as examples. Various further bus architectures are also conceivable for implementing the invention. For example, the bus users can be connected via one or more buses, for example CAN (Controller Area Network) with a high transmission speed and/or LIN, as an alternative or in addition to this it is possible, for example, for CAN with a relatively low transmission speed, D2B (Domestic Digital Bus), MOST (Media Oriented Systems Transport) and/or a wire free radio interface such as Bluetooth, to be used. The buses are then connected to one another in accordance with the degree of protocol conversion, for example by means of a router, a bridge or a gateway.

1. A vehicle data bus system including at least one data bus connected to a plurality of bus users for data transmission wherein:
a first one of said bus users is a sensor module having a rotational speed sensor, the sensor module outputting rotational speed data onto one of said at least one data bus
a second one of said bus users is a vehicle movement dynamic/wheel slip control system receiving at least the rotational speed data via said one data bus,
at least one further bus user receives the rotational speed data via said one data bus,
the sensor module preprocesses the rotational speed data and outputs the preprocessed rotational speed data onto said one data bus, and,
at least one of the vehicle movement dynamics/wheel slip control system and the at least one further bus user provides an offset correction of the received preprocessed rotational speed data.

2. A vehicle data bus system including at least one data bus connected to a plurality of bus users for data transmission wherein;
a first one of said bus users is a sensor module having a rotational speed sensor, the sensor module providing preprocessing of the rotational speed data, to carry out an offset correction of the preprocessed rotational speed data and outputting the offset-corrected rotational speed data onto one of the at least one data bus
a second one of said bus users is a vehicle movement dynamics/wheel slip control system receiving at least the offset-corrected rotational speed data via said one data bus
at least one further bus user receives the offset-corrected rotational speed data via said one data bus,
the vehicle movement dynamics/wheel slip control system receives at least wheel speed data via said one data bus, to acquire at least offset data and to output the offset data onto said one data bus, and
the sensor module receives at least the offset data via said data bus and acquires the offset-corrected rotational speed data using the offset data.

3. The vehicle data bus system as claimed in claim 2, wherein the sensor module is outputs the preprocessed rotational speed data onto said one data bus, and wherein at least one of the vehicle movement dynamics/wheel slip control system and the at least one further bus user are configured to receive the preprocessed rotational speed data and to carry out an offset correction of the preprocessed rotational speed data.

4. The vehicle data bus system as claimed in claim 1, wherein the preprocessing of the rotational speed data comprises oversampling and at least one of filtering and averaging the sensor data.

5. The vehicle data bus system as claimed in claim 1, wherein the vehicle movement dynamics/wheel slip control system is connected, for data transmission, to at least the at least one further bus user via a first data bus, and wherein the vehicle movement dynamics/wheel slip control system is connected, for data transmission, to at least the sensor module, via a second data bus.

6. The vehicle data bus system as claimed in claim 5, wherein the vehicle movement dynamics/wheel slip control system receives at least one of the preprocessed rotational speed data and/or the offset-corrected rotational speed data via the second data bus, and outputs the at least one of the preprocessed rotational speed data and the offset-corrected rotational speed data onto the first data bus.

7. The vehicle data bus system as claimed in claim 5 wherein the vehicle movement dynamics/wheel slip control system receives the wheel speed data via the first data bus, and outputs the offset data via the second data bus.

8. The vehicle data bus system as claimed in claim 1, wherein the rotational speed data comprises at least one of angle of rotation data and angle of rotation speed data and angle of rotation acceleration data.

9. The vehicle data bus system as claimed in claim 1, wherein the integration of the rotational speed data to form angle of rotation data takes place in at least one of the sensor module and a navigation module and the vehicle movement dynamics/wheel slip control system.

10. The vehicle data bus system as claimed in claim 1, wherein the sensor module further comprises at least one of a longitudinal acceleration sensor and a transverse acceleration sensor.

11. The vehicle data bus system as claimed in claim 1, wherein the at least one further bus user is one of a navigation module and a locating module.

12. The vehicle data bus system as claimed in claim 1, wherein the angle of rotation data is transmitted in a data message via said one data bus, the value of which data changes to 0° or from 0° to the maximum value as a function of the direction of rotation of the vehicle when a maximum value is reached.

13. The vehicle data bus system as claimed in claim 2, wherein the preprocessing of the rotational speed data comprises oversampling and at least one of filtering and averaging the sensor data.

14. The vehicle data bus system as claimed in claim 2, wherein the vehicle movement dynamics/wheel slip control system is connected, for data transmission, to at least the at least one further bus user via a first data bus, and wherein the vehicle movement dynamics/wheel slip control system is connected, for data transmission, to at least the sensor module, via a second data bus.

15. The vehicle data bus system as claimed in claim 14, wherein the vehicle movement dynamics/wheel slip control system receives at least one of the preprocessed rotational speed data and/or the offset-corrected rotational speed data via the second data bus, and outputs the at least one of the preprocessed rotational speed data and the offset-corrected rotational speed data onto the first data bus.

16. The vehicle data bus system as claimed in claim 6, wherein the vehicle movement dynamics/wheel slip control system receives the wheel speed data via the first data bus, and outputs the offset data via the second data bus.

17. The vehicle data bus system as claimed in claim 2, wherein the rotational speed data comprises at least one of angle of rotation data and angle of rotation speed data and angle of rotation acceleration data.

18. The vehicle data bus system as claimed in claim 2, wherein the integration of the rotational speed data to form angle of rotation data takes place in at least one of the sensor module and a navigation module and the vehicle movement dynamics/wheel slip control system.

19. The vehicle data bus system as claimed in claim 2, wherein the sensor module further comprises at least one of a longitudinal acceleration sensor and a transverse acceleration sensor.

20. The vehicle data bus system as claimed in claim 2, wherein the at least one further bus user is one of a navigation module and a locating module.
